(19) United States
(12) Patent Application Publication
(10) Pub. No.: US 2005/0098088 A1
(43) Pub. Date: May 12, 2005

(54) Portable signalling device

(76) Inventors: Massimo Tommaso Mazza, Teramo (IT); Carlo Fabri, Teramo (IT)

Correspondence Address: BIRCH STEWART KOLASCH & BIRCH, PO BOX 747, FALLS CHURCH, VA, 22040-0747, US

(21) Appl. No.: 10/939,499

(22) Filed: Sep. 14, 2004

Related U.S. Application Data
(63) Continuation of application No. PCT/EP04/01396, filed on Feb. 13, 2004.

(30) Foreign Application Priority Data
Feb. 14, 2003 (IT) MC2003A000019

(51) Int. Cl. B64B 1/40

(52) U.S. Cl. 116/210

(57) ABSTRACT

A signalling device suitable for being secured people and/or objects to be spotted at a distance, comprising a casing (1), anchoring means (3) suitable for constraining the casing (1) to a person's limb or an object in touch with a person, an inflatable body member (4) located in the casing (1) in a collapsed condition and having an inflation mouth (6), a cable (12) having one end thereof secured to the inflatable body member (4) and its other end anchored to the casing (1), a compressed fluid container (7) arranged to supply a fluid lighter than the air, valve means (9) in a closed condition designed to control fluid flow from the fluid container (7) to the inflation mouth (6), and control means (10, 11) arranged to open the valve means (9), thereby inflating the inflatable body member (4) and causing it to rise from the casing into the air while being anchored through the cable (12) to the casing (1) to constitute a spotting signal.

The present invention relates to a portable signalling device particularly useful for spotting a person to be rescued in the open, e.g. in the mountains, in a forest, in the open sea, in a crowd.

Rescue signalling devices currently available on the market have a number of drawbacks. Conventional acoustic rescue signalling devices are only operative over a limited range and poorly effective in specific environmental situations such as stormy seas, strong winds and, generally, very noisy environment. Moreover, generally speaking, it is sometimes impossible accurately to locate the spot where sound signals are generated by such devices, and thus it might be quite difficult to locate a person that has emitted an emergency signal.

Rescue signalling devices arranged to provide visual signals, such as rockets, fireworks and/or torches, have the inconvenience of requiring complex actuation procedures that are unfeasible in most emergency situations, and sometimes even dangerous. Moreover, the visual signal generated by them has a very limited duration. That is why this kind of visual signals are usually generated when the person or persons to be rescued are already in sight of a potential rescuer in the neighbourhood. Accordingly, in order to use such rescue signalling means with a reasonable chance of success, the person to be rescued must be alert and fully operational at all times, a condition that by and large is seldom the case, owing to the peculiar situation the person to be rescued is normally experiencing quite often in an injured and in any case debilitating condition.

A third type of rescue signalling devices comprises telephone, radio or satellite-based signalling devices that, besides being quite expensive, involve the use of power sources, such as batteries, which have a limited duration, and, if not supplemented by another apparatus, such as a sextant, a GPS system or the like, the person to be rescued is incapable of signalling his or her location. Satellite signalling devices do locate a requested position. An alarm signal can be provided, however, only after sending a communication to headquarters. Moreover, satellite signalling devices cannot ensure constant direct visibility of the point where a rescue operation is required, and thus they can be virtually unsuitable in some circumstances, e.g. in case of man overboard or similar events.

It is the main object of the present invention is to provide a reliable signalling device easy to use and highly effective for long distance sighting of people to be rescued.

Another object of the present invention is to provide a compact portable signalling device that can be attached to people, or clothing items, and the like.

Another object of the present invention is to provide an effective rescue signalling device which is quite simple in structure, and can be used in a wide range of situations.

A further object of the present invention is to provide a versatile signalling device that can be used both in wilderness (mountains, forests, sea) or in town such as to spot a child in a crowd.

A further object of the present invention is to provide a signalling device suitable for being built-into, and used in unison with other signalling means currently available on the market.

According to the present invention there is provided a signalling device suitable for being secured people and/or objects to be spotted at a distance, comprising a casing, anchoring means suitable for constraining said casing to a person's limb or an object in touch with a person, an inflatable body member located in said casing in a collapsed condition and having an inflation mouth, a cable having one end thereof secured to said inflatable body member and its other end anchored to said casing, a compressed fluid container arranged to supply a fluid lighter than the air, valve means in a closed condition designed to control fluid flow from said fluid container to said inflation mouth, and control means arranged to open said valve means, thereby inflating said inflatable body member and causing it to rise from said casing into the air while being anchored to said casing to constitute a spotting signal, characterized in that said casing has a removable lid member designed to be moved away from said casing by said inflatable body member while being inflated.

Advantageously, said control means comprises remote control means arranged to energize said valve means at a distance.

Further features and advantages of the present invention will better appear from the following description of some presently preferred embodiments thereof given by way of non limiting examples with reference to the accompanying drawings, in which:

FIG. 1 shows a top view of a closed casing provided with valve control means;

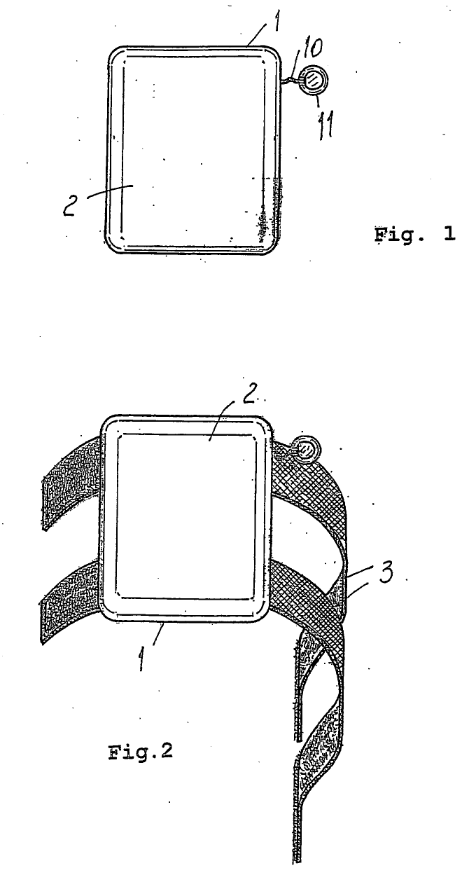

FIG. 2 illustrates the casing of FIG. 1 provided with anchoring means for application to an arm of a person or to a garment worn or a sac supported by a person;

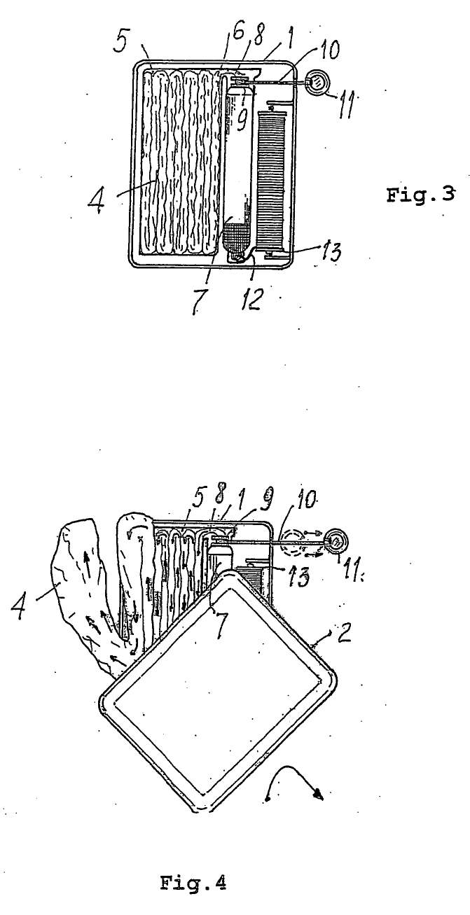

FIG. 3 is a top view of the casing of FIG. 1 where a covering lid has been removed;

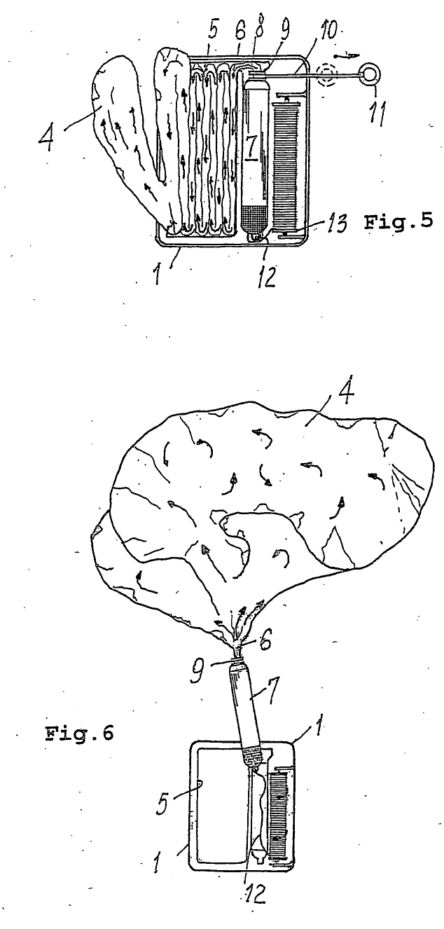

FIG. 4 shows a top view of the signalling device according to the present invention after the control means has been actuated and the inflatable body member is being inflated and the lid is being removed by it;

FIG. 5 shows the signalling device of FIG. 4 with its lid fully removed by the inflatable body member being inflated;

FIG. 6 is an elevation side view of the signalling device of FIG. 5 with the inflatable body member raising from the casing with the compressed fluid bottle attached to it;

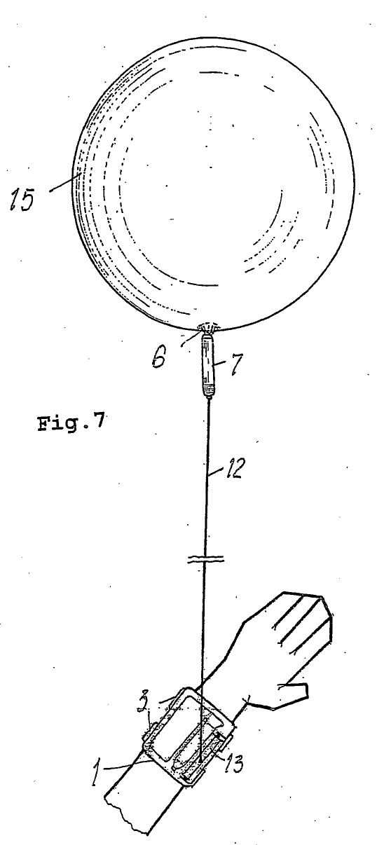

FIG. 7 illustrates an elevation view of the signalling of FIG. 6 with the inflatable body member in the shape of a balloon fully freed in the air from the casing and inflated while being anchored by a cable or rope to the casing secured to a person's arm;

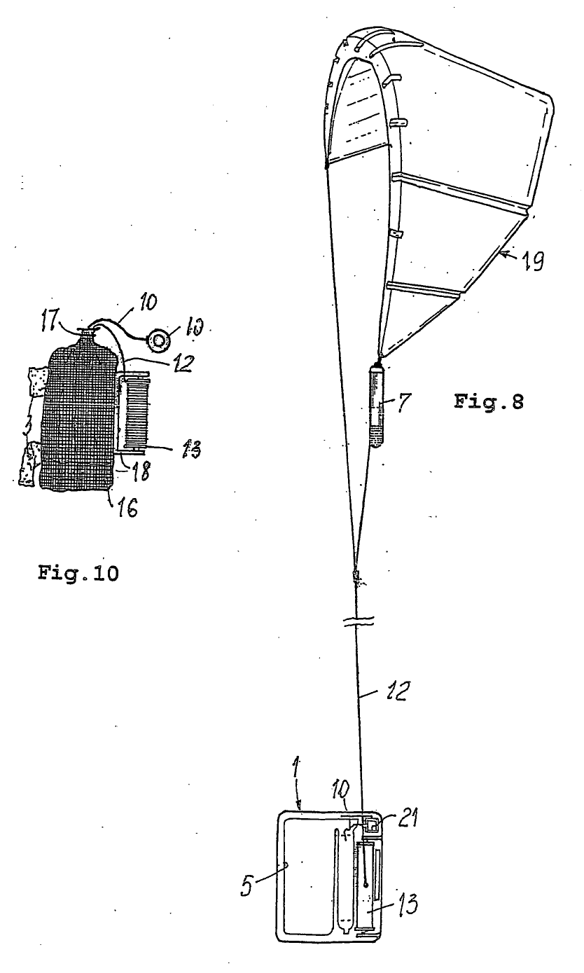

FIG. 8 shows another embodiment of the signalling device according to the invention in which the inflatable body member is in the shape of a crazy fly craft;

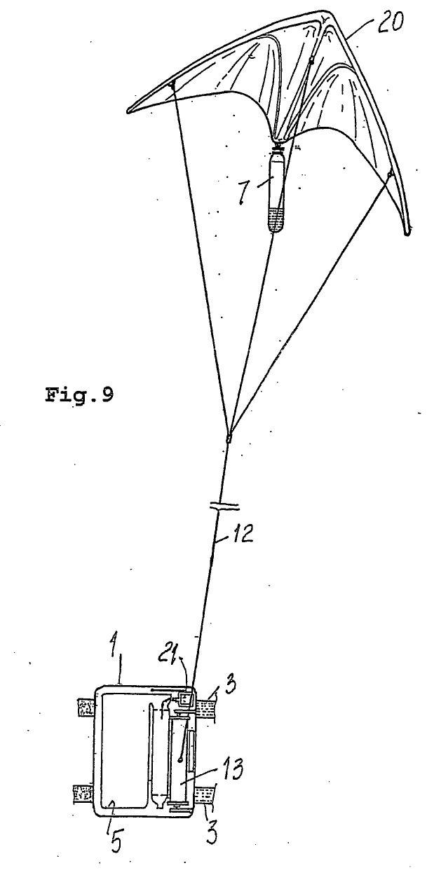

FIG. 9 illustrates a further embodiment of signalling device according to the present invention where the inflatable body member is in the shape of a kite balloon; and

FIG. 10 schematically shows a casing shaped as a bag or sac.

In the accompanying drawing similar parts or components are indicated with the same reference numerals.

With reference first to FIGS. 1 to 7, a signalling device according to the present invention comprises a casing 1 that can be a rigid or solid box provided with a removable lid or cover 2 or a pocket made of flexible textile or net or plastics material which can be opened by exerting pressure from inside. Casing 1 is provided with anchoring means, e.g. a pair of Velcro® straps 3 designed to be safely wound about an arm of a person or an object close to a person, such as a backpack, a garment, a boat, a wheel-chair, or the like.

An inflatable body member 4 of any suitable light material is located in a inner recess or space 5 of casing 1 in a collapsed condition and has an inflation mouth 6 connected in fluid communication with a compressed fluid container or bottle 7 secured to the body member 4 and arranged to supply thereto a fluid lighter than the air, e.g. helium, preferably through one or more ducts 8. A check valve 9 is provided between the mouth 6 and the bottle 7, to control fluid flow from the bottle 7 to the inflatable body member 4. Valve 9 is preferably mounted on an outlet end of bottle 7, as better shown in FIGS. 3 to 6 and can be manually actuated by control means, e.g. by means of a rope 10 having one end thereof drivingly connected to the check valve 9 end its other end secured to a handle 11 to be operated by user when in a difficult or emergency situation.

A relatively long cable 12 is wound on a spool 13 mounted for rotation in a suitable receiving seat 14 in the casing 1. Cable 12 has one end thereof secured to said inflatable body member, or preferably to the bottle 7, and its other end anchored to casing 1, i.e. secured to the spool 13 in turn constrained to casing 1.

With the above described structure, when handle 11 is pulled, rope 10 opens the check valve 9 and breaks away from it, while simultaneously pressurized fluid is fed to the body member 4 that starts being inflated in the casing 1, thereby exerting an increasing pressure on the removable lid 2 which is soon moved away (FIG. 4) from casing 1. Inflatable body member 4 frees itself from casing 1 and rises into the air like a balloon, while cable 12 is being unwound from spool 13 that is set in rotation. By the time cable 12 is fully unwound, body member 4 is well inflated and remains anchored in the air to constitute a durable spotting signal easily visible at distance.

Inflatable body member 4 can be shaped in a number of ways, e.g. as a balloon 15 as shown in FIG. 7, or a crazy fly craft 19 as shown in FIG. 8, or a kite balloon 20 as shown in FIG. 9, made of any suitable material, preferably coloured, e.g. with a phosphorescent colour or colours easier to be spotted at a distance.

The invention as described above is susceptible to numerous variations and modifications within the scope of the invention, as defined by the claims.

Thus, instead of using a rigid casing 1, a flexible and collapsible casing can be adopted, e.g. shaped as a sac or a bag 16 as shown in FIG. 10. Sac 16 is kept close by any suitable closing means, e.g. an elastic band 17, so that it can be relatively easily opened by the body member 4 while being inflated by the pressurized fluid in the bottle 7. Cable 12 can be either kept inside the bag 16 either wound into a ball or a skein, or arranged outside the bag wound on a spool 13 mounted for rotation on a suitable rigid support 18.

Moreover, check valve 9 can be opened by automatically operated control means, e.g. a small blasting charge, such as a water-responsive charge, i.e. a self-priming charge when in contact with water, or through a remote control means, in which case a battery-power unit of any suitable type, e.g. provided with an electric motor arranged to pull, upon control, cable 12, must be provided in casing 1 arranged to receive remote control signals and to energize the electric motor.

1. A signalling device suitable for being secured to people and/or objects to be spotted at a distance, including a casing (1), anchoring means (3) suitable for constraining said casing (1) to a person's limb or an object in touch with a person, an inflatable body member (4) located in said casing (1) in a collapsed condition and having an inflation mouth (6), a cable (12) having one end thereof secured to said inflatable body member (4) and its other end anchored to said casing (1), a compressed fluid container (7) arranged to supply a fluid lighter than the air, valve means (9) in a closed condition designed to control fluid flow from said fluid container (7) to said inflation mouth (6), and control means (10, 11) arranged to open said valve means (9), thereby inflating said inflatable body member (4) and causing it to rise from said casing into the air while being anchored to said casing (1) through said cable (12) to constitute a spotting signal, characterized in that said casing (1) has a removable lid member (2, 17) designed to be moved away from said casing (1) by said inflatable body member (4) while being inflated.
